(19) United States
(12) Patent Application Publication
(10) Pub. No.: US 2011/0093520 A1
(43) Pub. Date: Apr. 21, 2011

(54) AUTOMATICALLY IDENTIFYING AND SUMMARIZING CONTENT PUBLISHED BY KEY INFLUENCERS

(75) Inventors: John Doyle, East Twickenham (GB); Michael P. Lepore, Marlborough, MA (US); John A. Toebes, Cary, NC (US)

(73) Assignee: Cisco Technology, Inc.., San Jose, CA (US)

(21) Appl. No.: 12/582,198

(22) Filed: Oct. 20, 2009

(51) Int. Cl. G06F 15/16; G06F 15/173; G06F 11/07

(52) U.S. Cl. 709/203; 709/224; 714/32; 714/E11.026

(57) ABSTRACT

In one embodiment, a method includes accessing first data describing online activities of a user and accessing second data describing online activities of each of one or more content publishers. The method includes, based at least in part on the first data and the second data, determining one or more similarities between the user and each of the content publishers. The method includes, based at least in part on one or more of the similarities, selecting each of one or more of the content publishers as a key influencer for the user and selecting particular content published by a particular one of the key influencers for summary and delivery to the user. The method includes generating a summary of the particular content and automatically delivering to the user the particular content and the summary.

### TECHNICAL FIELD

This disclosure relates generally to summarizing content available over the Internet or other network.

### BACKGROUND

As the amount of content available over the Internet has grown, it has become difficult for an Internet user to search for and successfully locate specific content of interest to the user. Currently, there are methods for selecting and recommending particular content to particular users. Some methods attempt to personalize the selection of content for a particular user based on the particular tastes, interests, demographic information, etc. of the particular user. Some methods select particular content for a particular user based on feedback concerning the particular content received from a community of users.

Websites facilitating electronic commerce (e-commerce) may use these methods to recommend products or services to users as potential customers. There are a wide range of applications for these methods besides e-commerce. Moreover, there are a wide range channels for selecting or recommending a wide range of content for a wide range of users.

### BRIEF DESCRIPTION OF THE DRAWINGS

FIG. 1 illustrates an example system for automatically identifying and summarizing content published by key influencers.

FIG. 2 illustrates an example method for automatically identifying and summarizing content published by key influencers.

FIG. 3 illustrates an example computer system.

FIG. 4 illustrates a one-to-one relationship between a user and a piece of content.

FIG. 5 illustrates traditional collaborative filtering quality.

FIG. 6 illustrates traditional collaborative filtering.

FIG. 7 illustrates an example of socially relevant gestures.

FIG. 8 illustrates an example of finding related content.

FIG. 9 illustrates an example of generating personally interesting content.

FIG. 10 illustrates an example of generating relevant content.

FIG. 11 illustrates an example of improving quality of results.

FIG. 12 illustrates an example of similarity relationship.

FIG. 13 illustrates an example of using socially relevant gestures with similar content.

FIG. 14 illustrates an example of using similarity for personally interesting content.

### DESCRIPTION OF EXAMPLE EMBODIMENTS

### Overview

In one embodiment, a method includes accessing first data describing online activities of a user and accessing second data describing online activities of each of one or more content publishers. The method includes, based at least in part on the first data and the second data, determining one or more similarities between the user and each of the content publishers. The method includes, based at least in part on one or more of the similarities, selecting each of one or more of the content publishers as a key influencer for the user and selecting particular content published by a particular one of the key influencers for summary and delivery to the user. The method includes generating a summary of the particular content and automatically delivering to the user the particular content and the summary.

### DESCRIPTION

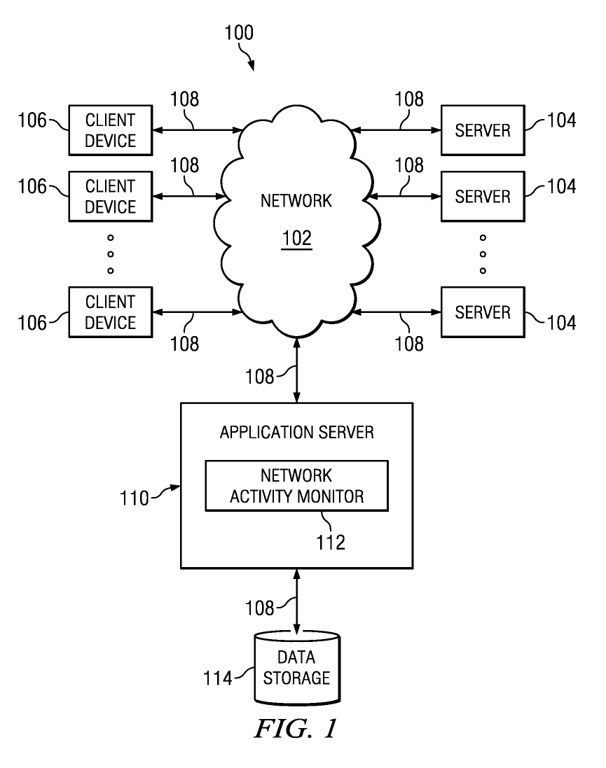

FIG. 1 illustrates an example system 100 for automatically identifying and summarizing content published by key influencers. System 100 includes network 102 coupling one or more servers 104 and client devices 106 to each other. In particular embodiments, network 102 is an intranet, an extranet, a virtual private network (VPN), a local area network (LAN), a wireless LAN (WLAN), a wide area network (WAN), a metropolitan area network (MAN), a portion of the Internet, or another network 102 or a combination of two or more such networks 102. The present disclosure contemplates any suitable network 102. Links 108 couple servers 104 and client devices 106 to network 102. In particular embodiments, one or more links 108 each include one or more wireline, wireless, or optical links. In particular embodiments, one or more links 108 each include an intranet, an extranet, a VPN, a LAN, a WLAN, a WAN, a MAN, a portion of the Internet, or another link 108 or a combination of two or more such links 108. The present disclosure contemplates any suitable links 108. A link 108 may include one or more links 108.

A server 104 may be internal or external to network 102 and may be directly or indirectly coupled to network 102. A server 104 may be unitary or distributed across multiple computer systems or datacenters, according to particular needs. Example servers include, but are not necessarily limited to, application servers, web servers, e-mail servers, database servers, content management servers, etc. The present disclosure contemplates any suitable servers 104. A client device may be directly or indirectly coupled to network 102. Example client devices include, but are not necessarily limited to, workstations, notebook computer systems, desktop computer systems, tablet computer systems, personal digital assistants (PDAs), mobile telephones, etc. The present disclosure contemplates any suitable client devices 106.

A client device 106 may communicate with one or more servers 104, one or more other client devices 106, or both via network 102 using one or more particular communication protocols, according to particular needs. The present disclosure contemplates any suitable communication protocols for communicating via network 102. Client device 106 may enable a person at client device 106 to interact with or otherwise access one or more services at one or more servers 104, interact or otherwise communicate with one or more other persons at one or more other client devices 106, or perform other actions using the Internet or one or more other networks. As an example and not by way of limitation, a client device 106 may enable a person at client device 106 to send or receive e-mail or instant messages (IMs), access web pages, publish information (such as content) at one or more web sites, or chat in one or more online chat rooms with one or more other persons at one or more other client devices 106.

As discussed above, one or more users at one or more client devices 106 may publish content. A user may be a person. Examples of content include but are not necessarily limited to text, image, video, audio, other content, or a combination of such content. The present disclosure contemplates any suitable content. To publish content, the user may post, upload, tag, comment, edit, e-mail, or otherwise publish the content on network 102. The user need not be the original creator of the content published by the user. Once a user has published content on network 102, in particular embodiments, the user is content publisher. All content publishers are users, but not all users are content publishers. Reference to a user may encompass a consumer of content from one or more content publishers, where appropriate. Reference to a publisher may encompass a creator or provider of content for consumption by one or more users, where appropriate.

A publisher of content may, but need not, be the original creator of the content published by the publisher. As an example and not by way of limitation, a first publisher may create and post a video clip to a first web site. A first user may view the video clip and post to a second web site the video clip or a link to the video clip. The first user, having posted to the second web site, is a second publisher. Both the first publisher and the first user (or second publisher) are publishers with respect to the video clip, even though the first user did not create the video clip. In contrast, if a second user only views the video clip (at either the first or second web site) and does nothing else with respect to the video clip that other users may consume (such as providing a rating of or comment on the video, posting the video or a link to the video to a third web site, recommending the video to one or more third users, etc.) then the second user is not a publisher with respect to the video clip. As another example, suppose a third user posted a rating or a comment on a book that the third user is not the author of. Although the third user is not the author of the book, the third user would be a publisher of the book, as well as the posted rating or comment. Similarly, suppose a fourth user tagged an audio clip that the fourth user is not the creator of. The fourth user would be a publisher of the audio clip, as well as tags that the user provided.

Particular embodiments select one or more key influencers for a user among the available content publishers. In particular embodiments, a key influencer selected for a user is a person who has sufficient similarity to the user. The similarity between the key influencer and the user may encompass multiple characteristics of the key influencer and the user, such as, for example, online activities, hobbies, interests, personalities, backgrounds, demographics, and other characteristics. Particular embodiments select the one or more key influencers for the user based on similarity between network (or Internet) activities of the user and the network activities of each of the available content publishers. The greater the similarity between the network activities of the user and the network activities of a content publisher, the greater the potential effect of the content publisher on the user as a key influencer. Particular embodiments select a key influencer for a user only if the key influencer has published at least one instance of content that is accessible to the user and do not select a key influencer for a user if the content publisher has published only content that is inaccessible to the user.

In the system of FIG. 1, an application server 110 is coupled to network 102 and a network activity monitor 112 resides at application server 110. Network activity monitor 112 may include a hardware, software, or embedded logic component or a combination of two or more such components for monitoring and collected data on the network activities of users on network 102. In particular embodiments, data storage 114 may store the collected network activity data for subsequent processing and analysis. Particular embodiments may use the network activity data to identify content publishers among the users, select key influencers for the users, or both.

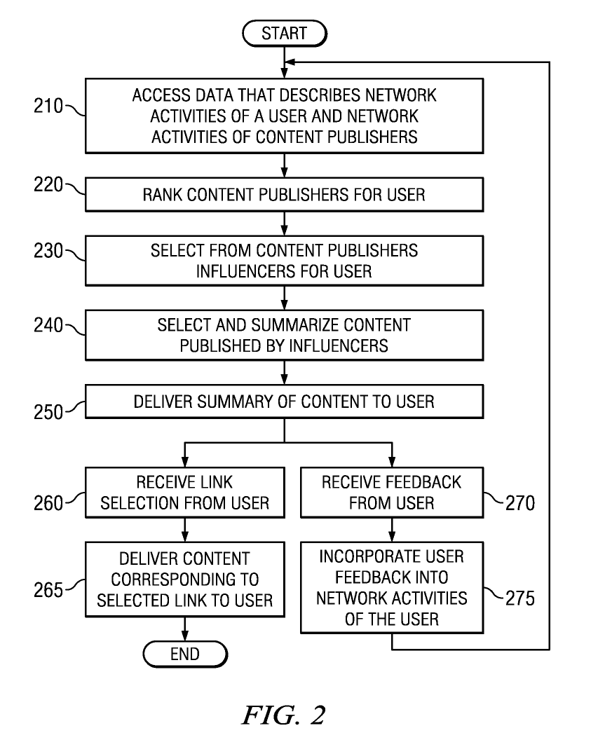

FIG. 2 illustrates an example method for automatically identifying and summarizing content published by key influencers. Particular embodiments automatically summarize content published by a selected key influencer for a user and deliver the summary to the user via one or more channels reaching the user. Although the present disclosure describes and illustrates particular steps of the method of FIG. 2 as occurring in a particular order, the present disclosure contemplates any suitable steps of the method of FIG. 2 occurring any suitable order. Similarly, the present disclosure contemplates any suitable components or devices carrying out any suitable portions of any suitable steps of the method of FIG. 2. Although the present disclosure describes and illustrates the method of FIG. 2 with respect to a single user, the present disclosure contemplates the method of FIG. 2 being applied to any suitable number of users.

Particular embodiments monitor the network activities of users on network 102 and collect and store data on the same. The present disclosure contemplates any suitable methods or devices for obtaining data on the network activities of users. The network activities of a user may include any activities that the user may perform on network 102, such as, for example, viewing web pages, selecting links on the web pages, rating or commenting on content, purchasing products or services online, and providing demographic information or information about hobbies or interests of the user. The present disclosure contemplates any suitable network activities of any suitable users. Particular embodiments process and analyze data one the network activities of a user and the network activities of each of the content publishers with respect to the user, for example, as illustrated by step 210 of FIG. 2. The present disclosure contemplates the data being stored in any suitable formats at any suitable locations.

In particular embodiments, a user's network activities may be used to identify the user's preferences. Similarly, a content publisher's network activities may be used to identify the content publisher's preferences. Using the user's network activities as an example, any and all network-based activities by the user may be identified relative to a context presented to the user, namely the input options presented to the user. The user selection preferences may be identified based on accumulating the identified network-based activities relative to the context presented to the user, including not only accumulating the user selection inputs executed by the identified user, but also identifying and accumulating the input options that were presented (e.g., offered) to the user but ignored by the user. Consequently, the user selection inputs may be more precisely evaluated when compared in context with the other input options that were presented to the user (e.g., at the same time as the input option selected by the user), but that were ignored by the identified user based on detecting the respective input options were not selected by the user.

The accumulation of user selection inputs by the user, relative to the context of the input options presented to the user but ignored by the user, demonstrate “socially relevant gestures” that may be used to identify the user preferences. Socially relevant gestures may include, for example and without limitation: identifying the user for example based on user login or detecting a unique identification token (e.g., an RFID tag, a digital signature, a cookie, etc.); identifying a physical or network location of the user (e.g., based on presence information or locality information provided either explicitly or inherently by a user device utilized by the user to access the network); identifying content that the user has chosen historically with respect to viewed content (e.g., tracking what television shows, movies, etc. a user has viewed and for how long, or identifying a location within presented content where a user changes his or her interest to other content or browsed content); identifying content or items that the user has commented on, for example within online forms or communities; identifying network access activities by the user, for example types of user devices used to access network items, duration of access, whether multiple access devices are concurrently utilized, etc.

Particular embodiments may rank the content publishers with respect to the user, for example, as illustrated by Step 220 of FIG. 2. The ranking may be based on one or more indications of similarities between preferences of the user and preferences of the content publishers. As an example and not by way of limitation, the user may provide a set of criteria describing or otherwise indicating interests of the user. The user may prefer Italian wine over French wine, drama movies over horror movies, basketball over baseball, etc. Or the user may like sports, travel, photography, etc. Particular embodiments may use the set of criteria to determine how similar a particular content publisher is to the user with respect to their personal preferences. As an example and not by way of limitation, if the user has indicated that the user likes science fiction and the content publisher has published content related to science fiction, there may be similarities between the user and the content publisher. On the other hand, if the user has indicated that the user dislikes Mexican food and the content publisher has published content praising Mexican food dishes, the user and the content publisher may have dissimilar tastes in food.

Network activities of a user may indicate preferences, interests, or tastes of the user, and network activities of a content publisher may similarly indicate preferences, interests, or tastes of the content publisher, as described above. As an example and not by way of limitation, if the user has purchased a history book online, the online purchase may indicate that the user is interested in history. A content publisher who has purchased the same history book may be in history similar to the user. If the user posts a positive review or rating of a particular movie to a web page, the posting may indicate that the user likes the particular movie. If the user has selected a link on a web page, the selection may indicate that the user is interested in the content provided by the web page that the link directs the user to. The present disclosure contemplates any suitable network activities of any suitable user or content publisher indicating any suitable preferences, interests, or tastes of the user or the content publisher.

Particular embodiments may use any suitable explicit or implicit information that indicates personal preferences of the user and personal preferences of each of the content publisher to determine the level of similarity between the user and each of the content publishers. It is unlikely that two persons will have similar preferences or interests in all respects. It is more likely that two persons will have some similar and some dissimilar preferences or interests. In particular embodiments, the greater the number of common interests between the user and a content publisher, the greater the similarity between the user and the content publisher.

Particular embodiments may give a higher ranking to a content publisher having a higher level of similarity in preferences to the user. If two content publishers have approximately the same level of similarity in preferences to the user, particular embodiments may give a higher ranking to the content publisher who has published more content than the higher.

In addition or as an alternative to ranking content publishers based on similarities between preferences of the user and preferences of each of the content publishers, particular embodiments may rank the content publishers based feedback received from the user, for example, as illustrated by step 270 of FIG. 2 and further described below.

Particular embodiments select one or more key influencers for the user from among the content publishers, for example, as illustrated by step 230 of FIG. 2. Particular embodiments select the key influencers based on the levels of similarities in preferences between the user and the content publishers. The more similar the preferences of the user to the preferences of a particular content publisher, the more likely it is that the particular content publisher will be selected as a key influencer for the user. Moreover, the more similar the preferences of the user to the preferences of a particular content publisher, the more likely it is that the particular content publisher will be a stronger effect on the user as a key influencer.

Particular embodiment select key influencers for the user according to the rankings they received as content publishers. As an example and not by way of limitation, the n top ranked or the top n percentile of content publishers by rank (where n is a predetermined number) or the content publishers with similarity levels above a predetermined threshold may be selected as key influencers for the user. In particular embodiments, the key influencers selected for the user are content publishers who are more similar to the user in their interests, preferences, tastes, and so on. Such key influencers are more “like” the user.

Particular embodiments may select among the content published by the key influencers selected for the user particular instances of content and then generate summaries of the particular instances of content selected, for example, as illustrated by step 240 of FIG. 2. As described above, an instance of content may include text (such as, for example, one or more particular articles, essays, academic or technical papers, messages, comments, ratings, tags, or posts), video (such as, for example, one or more particular portions of one or more particular movies or home-made video clips), audio (such as, for example, speech or music), or a suitable combination of the preceding.

Each key influencer selected for the user may have published many instances of content. As described above, one or more preferences of a key influencer may differ from one or more preferences of the user. Particular embodiments select only instances of content published by a key influencer that relate to matters of common interest or preference between the key influencer and the user. Particular embodiments may receive a specification from the user of the types of content the user prefers and select only instances of content published by the key influencer that relate to the types of content specified by the user. As an example and not by way of limitation, suppose that a content publisher has published ten instances of content, five related to oil painting, two related to photography, and three related to tennis. Further suppose that the user likes painting and photography but is not particularly interested in tennis. The seven instances of content published by the content publisher that are related to oil painting and photography may be selected for the user, whereas the three instances of content relating to tennis may not be.

As described above, a user's preferences may be determined based on the user's network activities. Particular embodiments use the identification of the user selection preferences for a given user (based on having detected the socially relevant gestures of the user) with available network information in order to dynamically generate recommendations for the user that are based on a collaborative filtering of the user selection preferences with the network information. Thus, applying collaborative filtering to the user selection preferences in combination with the network information results in a socially collaborative filtering of content that is personalized precisely for the user.

In particular embodiments, the network information may include one-way relationships that demonstrate affinities of a given network object toward another network object. For example and without limitation, the network information may include one-way user-user relationships, one-way user-item relationships, one-way item-item relationships, and one-way item-user relationships. Each of these relationships may be determined based on socially relevant gestures and stored in an appropriate database, e.g., data storage 114, for future use, for example and without limitation, updating the relationships in response to additional detected socially relevant gestures.

The socially collaborative filtering may provide personalized and context-sensitive recommendations for a user, e.g., recommendations of particular instances of content published by particular influencers selected for the user, that may be updated in response to each detected socially relevant gesture by the user. Particular embodiments may update the user selection preferences for a given user in response to each successive user selection input, including the corresponding context, and in response successively generate corresponding updated content recommendations for the user.

The updating of the user selection preferences in response to each socially relevant gesture by a user may be used to increase an affinity for the instances of content published by a user's influencers being presented to the user, in other words, strengthening the relationship between the user and the instances of the content being presented to the user. The updating of the user selection preferences also may be used to decrease an affinity for the instances of content being presented to the user in order to decrease the strength of the corresponding relationship, for example, in the case of instances of content that are ignored by the user, or detection of socially relevant gestures demonstrating that the user exhibits a dislike for certain instances of content.

In particular embodiments, the network users, including content publishers may be divided into multiple levels of user affinity categories with respect to viewing and creating instance of content. For example and without limitation, a lurker category of users may include all network users who have viewed or published particular instances of content. The lurker category may include a subcategory of content publisher category. The subcategory of content publishers is distinguishable from the lurker category in that each user in the content publisher subcategory has published at least one instance of content, e.g., content publishers. The content publisher category may further include a subcategory of key influencers. The subcategory of key influencers is distinguishable from the content publisher subcategory in that the key influencers have published a sufficiently large number of instances of content that generate substantially favorable feedback or responses from other users having viewed the content published by the key influencers.

In particular embodiments, if a content publisher has only published a relatively few instances of content that are insufficient to generate a substantial number of responses or feedback by the other users, the content publisher may be automatically disqualified from being considered as a key influencer for other users.

Particular embodiments may deduplicate content selected for the user, as a key influencer may have published one or more instances of content multiple times or multiple key influencers may have published the same instance of content one or more times each. The present disclosure contemplates any suitable methods or devices for deduplicating content. In particular embodiments deduplicating content involves removing any duplicates of content from a set of content, where appropriate. As an example and not by way of limitation, particular embodiments may select content for a user and then deduplicate the selected content by identify duplicates of content among the selected content and removing identified duplicates of the content so that the user does not receive duplicates of any selected content.

Instead of providing complete instances of content selected for the user, particular embodiments may generate a brief description of all or some of the instances of content and provide it to the user with links to the complete instances of content selected. This may give the user the option of receiving the complete instances of content only if the user so desires and may save bandwidth with respect to the instances of content that the user is not interested in.

Particular embodiments order instances of content selected for the user based on one or more ordering criteria. As an example and not by way of limitation, particular embodiments may place content published by a stronger key influencer with respect to the user before content published by a weaker key influencer with respect to the user. As another example, particular embodiments may place content related to matters of more interest to the user before content related to matter of less interest to the user.

Particular embodiments apply socially collaborative filtering to ranking content publishers and selecting influencers for a user and selecting contents published by the particular influencers for the user. Particular embodiments establish relationships between the user and the content publishers or between the user and the instances of content published by the content publishers based on artificially creating socially relevant gestures between the user and the content publishers or the instances of content.

Particular embodiments deliver to the user the summary of the instances of content selected for the user, for example, as illustrated by step 250 of FIG. 2. The present disclosure contemplate any suitable channel or method for delivering the summary to the user. As an example and not by way of limitation, particular embodiments may deliver the summary to the user in one or more Really Simple Syndication (RSS) feeds, in one or more e-mails, or one or more IMs.

When the user receives the summary, the user may respond to it. As an example and not way of limitation, on viewing the summary, the user may be interested in one or more specific instances of content based on their brief descriptions and want to view the complete instances of content. The user may click on or otherwise select one or more links provided with the brief descriptions of the instances of content in the summary, and client device 106 of the user may communicate one or more client requests to one or more appropriate servers 104. When a link selection is received from the user (for example as illustrated by step 260 of FIG. 2) the complete instance of content corresponding to the selection made by the user may be retrieved and delivered to the user, for example, as illustrated by step 265 of FIG. 2.

When the user views the summary or one or more complete instances of content, the user may want to rate or comment on the quality of the summary or the complete instances of content. The present disclosure contemplates any suitable methods of devices for rating or commenting on the quality of the summary or the complete instances of content. As an example and not by way of limitation, the user may provide a rating along a rating scale, e.g., between 1 to 5, or provide a binary rating, e.g., thumb up or thumb down. Particular embodiments may communicate such ratings back as user feedback on the summary or the instances of content selected for the user, for example, as illustrated by step 270 of FIG. 2.

Particular embodiments may use feedback provided by the user to refine the selection of key influencers or instances of content for the user. Particular embodiments may incorporate the user feedback as a part of the network activities of the user, for example, as illustrated by step 275 of FIG. 2, so that subsequently, when the content publishers are ranked again for the user based on the network activities of the user and the network activities of the content publishers, the user feedback, now incorporated in the network activities of the user, also influence the ranking of the content publishers for the user, for example, as illustrated by step 210 of FIG. 2. The process illustrated in FIG. 2 is thus capable of self learning. As an example and not by way of limitation, if feedback from the user consistently indicates that the user is satisfied with the content selected for the user, particular embodiments may determine that the key influencers selected for the user have preferences similar to the user and the content selected for the user relate to matters that the user is interested in. As another example, if feedback from the user consistently indicates that the user is dissatisfied with the content selected for the user, particular embodiments may make adjustments to select different key influencers or different content for the user. As another example, if the feedback from the user indicates that the user is frequently dissatisfied with content published by a particular key influencer selected for the user, particular embodiments may determine that the particular key influencer is unlike the user and remove the particular key influencer from the key influencers selected for the user.

Particular embodiments may update or reselect key influencers or content for the user. Particular embodiments may update or reselect as feedback or other data describing the network activities of the user or key influencers becomes available. As an example and not by way of limitation, particular embodiments may update or reselect every time the user provides feedback. Particular embodiments may update or reselect on a predetermined periodic basis, such as once a day.

Since user feedback is provided by the user with respect to the instances of content presented to the user, particular embodiments may present a set of contents, e.g., a test set of contents, to the user in order to obtain user feedback on these test contents. This step may be performed as a part of the preprocessing or initialization. The test contents may include contents covering a variety of subject matters. From the feedback provided by the user with respect to these test contents, it may be determined which types of contents are preferred by the user and which are not. This may improve the efficiency on selecting those contents that the user prefers.

Particular embodiments use socially collaborative filtering to track user feedback or responses to the instances of content presented to the user, which enable the selection of subsequent instances of content for the user to be dynamically updated based on whether the user responds positively or negatively to the previously presented instances of content.

Sometimes, a particular user may not have sufficient information about him to determine his preferences. Consequently, if may not be possible to select key influencers for such a user based on similarities between the user and other content publishers. In this case, particular embodiments may initially provide a random or neutral introduction of available content to the user. As more information about the user is collected, e.g., via user feedback of the presented content, the user's preferences may be determined and subsequently used to select key influencers and content for the user.

Particular embodiments may be implemented as hardware, software, or a combination of hardware and software. As an example and not by way of limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

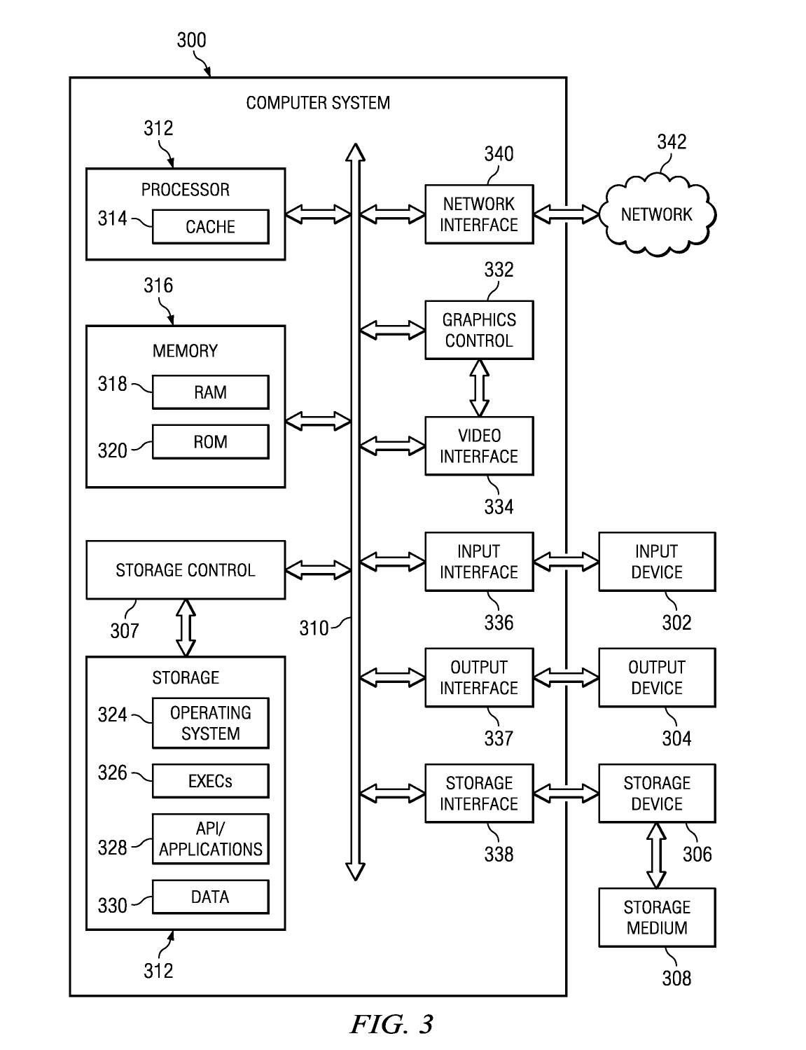

For example, FIG. 3 illustrates an example computer system 300 suitable for implementing one or more portions of particular embodiments. Although the present disclosure describes and illustrates a particular computer system 300 having particular components in a particular configuration, the present disclosure contemplates any suitable computer system having any suitable components in any suitable configuration. Moreover, computer system 300 may have take any suitable physical form, such as for example one or more integrated circuit (ICs), one or more printed circuit boards (PCBs), one or more handheld or other devices (such as mobile telephones or PDAs), one or more personal computers, or one or more super computers.

Computer system 300 may have one or more input devices 302 (which may include a keypad, keyboard, mouse, stylus, etc.), one or more output devices 304 (which may include one or more displays, one or more speakers, one or more printers, etc.), one or more storage devices 306, and one or more storage medium 308. An input device 302 may be external or internal to computer system 300. An output device 304 may be external or internal to computer system 300. A storage device 306 may be external or internal to computer system 300. A storage medium 308 may be external or internal to computer system 300.

System bus 310 couples subsystems of computer system 300 to each other. Herein, reference to a bus encompasses one or more digital signal lines serving a common function. The present disclosure contemplates any suitable system bus 310 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 300 includes one or more processors 312 (or central processing units (CPUs)). A processor 312 may contain a cache 314 for temporary local storage of instructions, data, or computer addresses. Processors 312 are coupled to one or more storage devices, including memory 316. Memory 316 may include random access memory (RAM) 318 and read-only memory (ROM) 320. Data and instructions may transfer bidirectionally between processors 312 and RAM 318. Data and instructions may transfer unidirectionally to processors 312 from ROM 320. RAM 318 and ROM 320 may include any suitable computer-readable storage media.

Computer system 300 includes fixed storage 322 coupled bi-directionally to processors 312. Fixed storage 322 may be coupled to processors 312 via storage control unit 307. Fixed storage 322 may provide additional data storage capacity and may include any suitable computer-readable storage media. Fixed storage 322 may store an operating system (OS) 324, one or more executables (EXECs) 326, one or more applications or programs 328, data 330 and the like. Fixed storage 322 is typically a secondary storage medium (such as a hard disk) that is slower than primary storage. In appropriate cases, the information stored by fixed storage 322 may be incorporated as virtual memory into memory 316.

Processors 312 may be coupled to a variety of interfaces, such as, for example, graphics control 332, video interface 334, input interface 336, output interface 337, and storage interface 338, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 340 may couple processors 312 to another computer system or to network 342. With network interface 340, processors 312 may receive or send information from or to network 342 in the course of performing steps of particular embodiments. Particular embodiments may execute solely on processors 312. Particular embodiments may execute on processors 312 and on one or more remote processors operating together.

In a network environment, where computer system 300 is connected to network 342, computer system 300 may communicate with other devices connected to network 342. Computer system 300 may communicate with network 342 via network interface 340. For example, computer system 300 may receive information (such as a request or a response from another device) from network 342 in the form of one or more incoming packets at network interface 340 and memory 316 may store the incoming packets for subsequent processing. Computer system 300 may send information (such as a request or a response to another device) to network 342 in the form of one or more outgoing packets from network interface 340, which memory 316 may store prior to being sent. Processors 312 may access an incoming or outgoing packet in memory 316 to process it, according to particular needs.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 316 may include one or more computer-readable storage media embodying software and computer system 300 may provide particular functionality described or illustrated herein as a result of processors 312 executing the software. Memory 316 may store and processors 312 may execute the software. Memory 316 may read the software from the computer-readable storage media in mass storage device 316 embodying the software or from one or more other sources via network interface 340. When executing the software, processors 312 may perform one or more steps of one or more processes described or illustrated herein, which may include defining one or more data structures for storage in memory 316 and modifying one or more of the data structures as directed by one or more portions the software, according to particular needs. In addition or as an alternative, computer system 300 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Particular embodiments may apply socially collaborative filtering to select contents published by the influencers for the users. Socially collaborative filtering may offer improved recommendations that are targeted to the individual. In contrast to traditional collaborative filtering, socially collaborative filtering is based on socially relevant gestures that provide greater insight into how users perceive content. These gestures inform a list of personally interesting content and personalized recommendations that are more relevant to the user. Applying what has been learned about one item to a new item builds a similarity relationship, which may be used, along with socially relevant gestures, to reduce the time it takes for new content to be recommended.

Broadband adoption and the digitization of content are empowering consumers and fundamentally changing the entertainment experience. The number of entertainment choices and delivery methods has grown dramatically due to the digitization of content. As a result, users are now faced with the challenge of discovering content that interests them, while at the same time finding ways to connect to that content. Users want to have a more personalized experience where they may interact with content and other users.

Users want an engaging web experience that is both relevant and interesting for them. Given the wide variety of content available on any one website, it is not reasonable to expect the user to have to pinpoint the content which may interest them, nor can all users be expected to be interested in the most popular content. The situation demands a recommendation system that takes into account both the needs of the individual user and the combined effect of other people who have similar interests.

“Collaborative filtering” in its traditional sense is the process of filtering for information or patterns using techniques involving collaboration among multiple agents, viewpoints, data sources, and the like. Applications of collaborative filtering typically involve very large data sets. Collaborative filtering methods have been applied to many different kinds of data including web 2.0 applications where the focus is on user data.

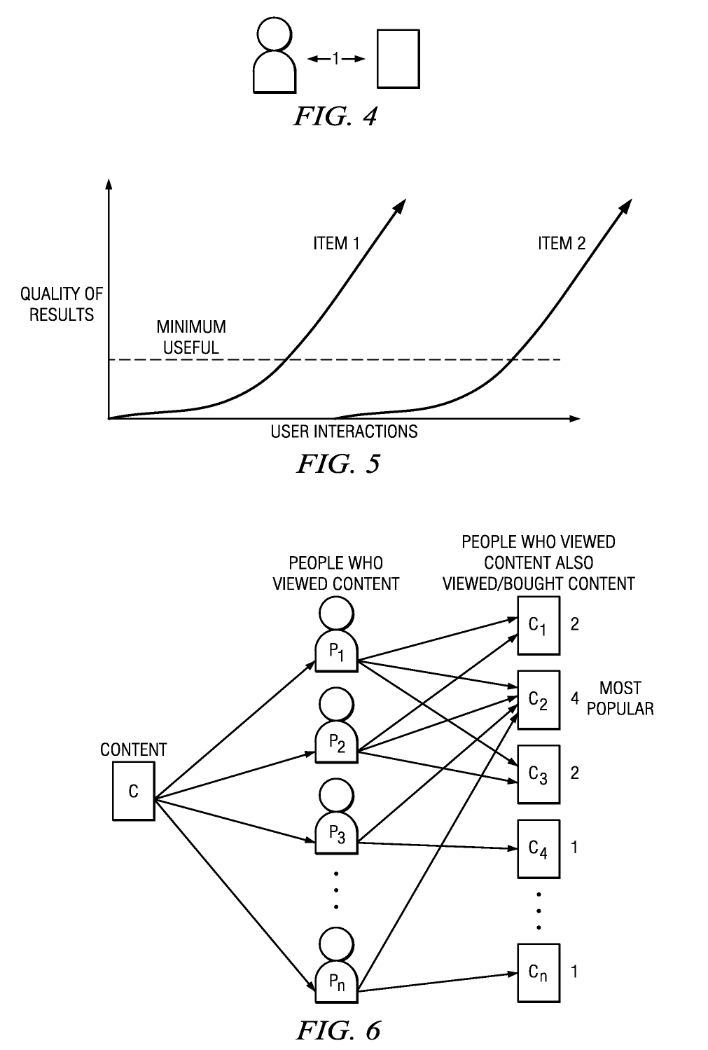

The traditional, standard approach to making recommendations to a user in order to encourage them to buy a product is through a form of collaborative filtering in which the system tracks all the items a user touches. The resulting database of 1-to-1 relationships between a user and any piece of content, as illustrated in FIG. 4, is easy to update and quick to access. The system may also keep track of the relationship for items a user has viewed as well as bought.

When another user views the item, the system may then find a list of all users who have also viewed the item, and then for all of those users it may generate a list of all the content that those people have also viewed. By summing up the number of times an item appears in the second list, it is easy for the system to generate a list of the most popular items related to it. In this way, the system quickly generates a list of items which have been most popular in the past. FIG. 6 illustrates an example of traditional collaborative filtering.

However, this simple approach is not without problems. The first has been called “the Harry Potter problem”, meaning that any extremely popular book will show up on the list for any book in any genre, reducing the effectiveness of the recommendations. The second and more difficult problem is the time it takes for a meaningful recommendation to be made. In order to make any reasonable recommendation for an item, a minimum number of relationships must be established between that item and users. This is typically solved by introducing another mechanism by which a user may discover an item—either through search or some other directory. Unfortunately, the user must navigate through two different mechanisms to find their content just to satisfy the algorithm. The third problem is that every new item, no matter how close to an existing item, must go through this learning curve before it too may be recommended. As a result there is a delay from the time the content is introduced until the content may be recommended. Lastly, and most importantly, collaborative filtering makes the same recommendations to everyone who views an item. While this is useful for the majority of users, it ignores the differences in interest that many people have. FIG. 5 illustrates an example of traditional collaborative filtering performance.

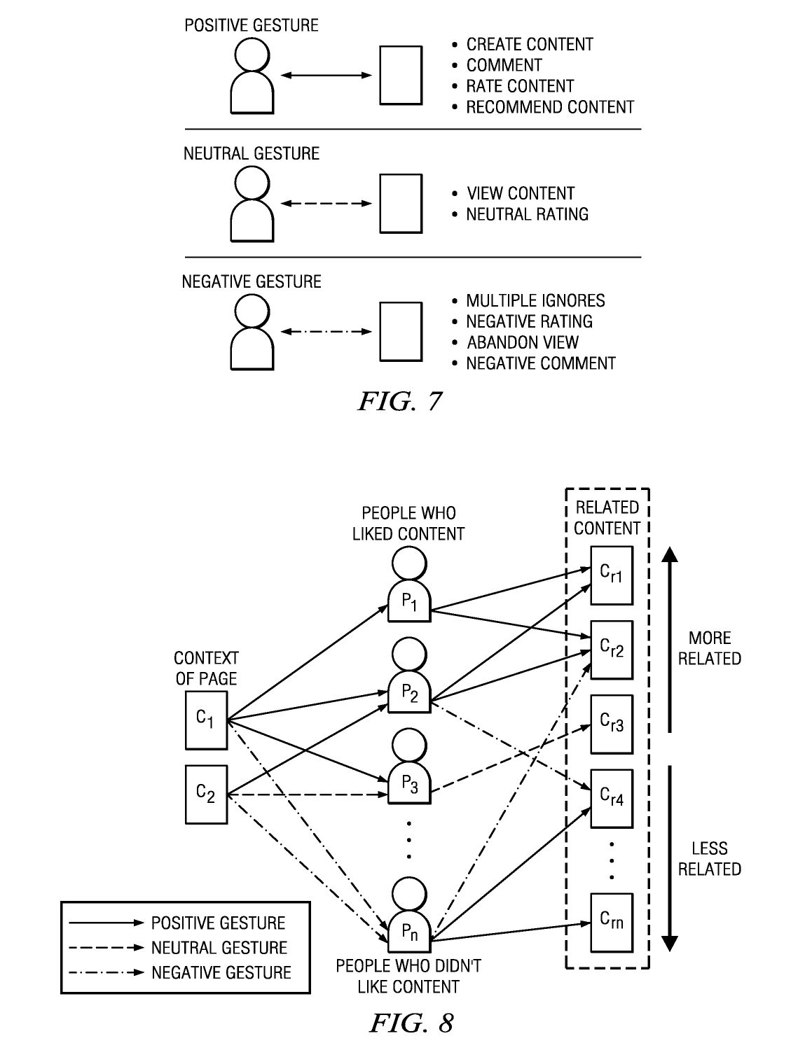

In order to produce a set of recommendations more targeted to the individual, it may be necessary to have a richer understanding of how the user interacts with the content. A user may take a range of actions on any piece of content, from strongly positive actions such as creating the content or giving it a very positive rating, to negative actions where a user provides a negative comment about the content. These actions are called “socially relevant gestures” (SRGs), as illustrated in FIG. 7, because they provide insight into how a user perceives the content.

As in traditional collaborative filtering, in particular embodiments, socially relevant gestures are stored in a database that tracks the relationship between an individual and the content. However, the type and strength (positive, negative, or neutral) of the gesture is also stored, and this information may be used in conjunction with other SRGs to develop a prioritized list of content and people as they relate to other content, as illustrated in FIG. 8.

To understand how socially collaborative filtering works, consider the content related to C₁ and C₂ in FIG. 8 as an example. Imagine that this content consists of a couple of video clips, and the task is to find other related clips to show. Starting with these two content items, all of the people must be discovered who have expressed an interest in that content. Because these gestures have relative weight, the values for the gestures may be summed up and an ordered list of people may be produced from P₁ to Pₙ, where people at the top of the list expressed the most positive gestures toward the content and people on the bottom expressed the most negative gestures.

Given this ordered list of people who are related to the content, all of the gestures that the people expressed toward other content may be examined, again using the relative weight of the gestures to generate a prioritized list of Related Content Cᵣ₁ through Cᵣₙ. Note that in this case, the people who disliked the original content and also disliked another piece of content affect the priority of how results are weighted in the list. This differs greatly from collaborative filtering (as illustrated in FIG. 5) in that it is now clear which content is inversely related to the original content because of the gestures.

Finding the list of related content using SRGs is a good start, but it does not personalize the content to an individual. The same list is produced, no matter who is looking at the content. To address this issue, in particular embodiments, a list of personally interesting content must be generated that covers all of the content that may be interesting to a user—either positive or negative. Given SRGs, a list may be constructed of both content that the user should like and content that they do not like.

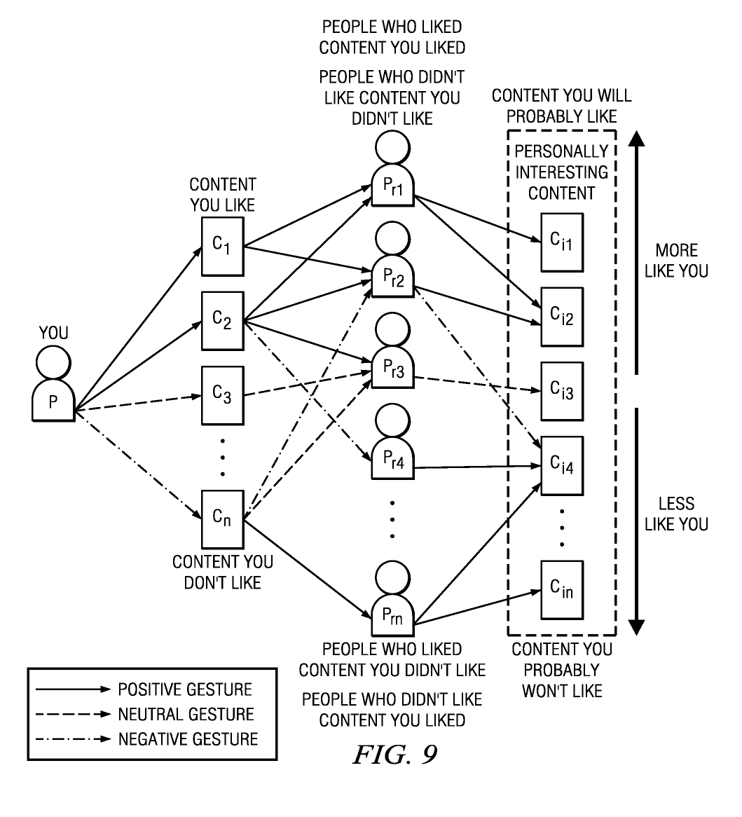

FIG. 9 illustrates an example of how these relationships may be used to first generate an ordered list of all the content in which a user has expressed an interest (C₁ through Cₙ). Then all the other users who have expressed gestures toward that content are found and ordered to produce a list Pᵣ₁ through Pᵣₙ of people who range from liking content that the user liked all the way to disliking content that the user liked. The gestures that these people have expressed toward all other content make it possible to generate the complete list of personally interesting content Cᵢ₁ through Cᵢₙ for the original user.

Several useful observations may be made about the resulting list. First, it is extremely large and thus could take some time to generate. However, because of the nature of the large number of gestures that went into forming it, the list does not change very much over time with only minor adjustments to the order of individual items. This slow rate of change means the list may be calculated less frequently and cached for multiple operations.

From the list, content may be recognized that should be avoided due to its negative relationship to the user. Even more useful is the content in the middle, such as Cᵢ₃, which may be used as an opportunity to discover more about a user's tastes when they have gone through much of the content that it is known they like.

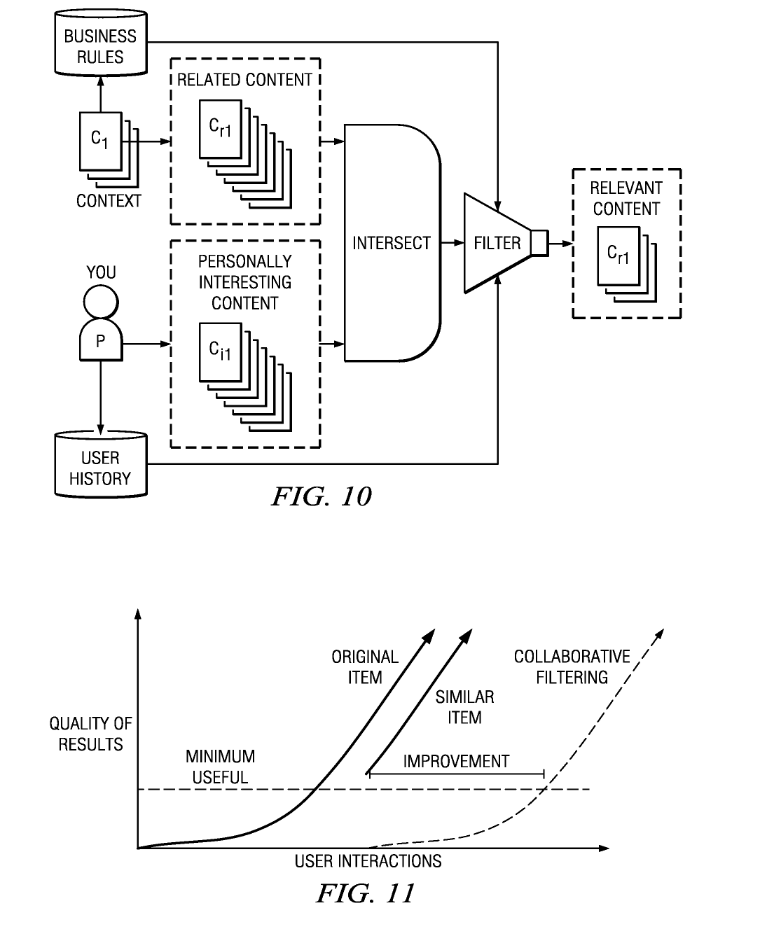

Given the personally interesting content, the mechanism for finding related content may now be refined in a way that is unique to each user. When two people come to the same place to look at some content, in particular embodiments, it is preferable for the recommendations related to that content to be different if the users have different tastes. In effect, the goal is to distill the relevant content from the related content. FIG. 10 illustrates this process.

A list may be generated of related content for any content—for example, a video playlist. Then, from the user's personally interesting content, an intersection of prioritized content may be generated. Next, business rules may be applied to that content, such as age and location restrictions. A user history may also be applied to that filtered content to drop out any content which the user may have recently seen. The combination of business rules and user history makes it possible to generate the list of relevant content that is unique to the user.

If a user has seen all the filtered content, an empty list could potentially occur. To accommodate this scenario, the list may be pre-seeded with content that is not expected to be filtered, and content may be added back when the list is found to be empty. The result is that recommendations are now both related to the content and relevant to the end user.

One problem that SRGs do not solve is reducing the time it takes for new content to be recommended. This process may be expedited by taking advantage of the fact that new content that is added is often similar to content that is previously known. FIG. 11 illustrates how the quality of results may be improved.

Applying what has been learned about an original item to a new item that is similar, what is already known about that item may be utilized to produce immediate recommendations for the new item. To do this, in particular embodiments, first, a similarity must be determined between one item and another. This may be done in a number of ways. When there is a significant amount of metadata about an item, the metadata may often be compared to discover how similar it is. If the content is episodes of a television series, it may certainly be assumed that a new episode will have substantially similar content to any previous episode.

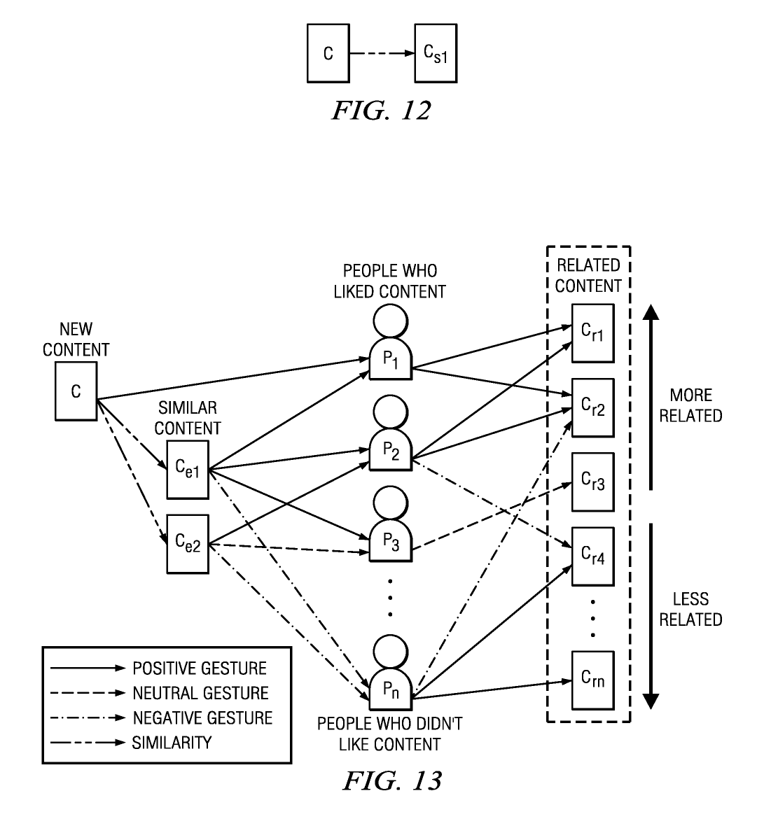

Other content may require closer inspection to determine its similarity. This inspection may include technology such as image, text, and even semantic analysis. Many companies are now working in this area with video, music, and even text snippets. Given this analysis, a similarity database may be constructed to show the relationship between any content item C and a corresponding item Cₛ₁, as illustrated in FIG. 12.

This similarity relationship may now be used to build the related content for any new content by using the SRGs for the similar content as shown in FIG. 13. Attention must be paid to the minimum number of useful interactions before a recommendation may effectively be made. Assume the minimum number to be 10 interactions. Starting with no interactions to determine the related content, 100 percent of the gestures associated with the similar content is used. Once a single gesture is received, the dependency on the similar content may be reduced to 90 percent. As more gestures are received, dependency on the similar content is gradually reduced until the recommendation is based 100 percent on the actual gestures.

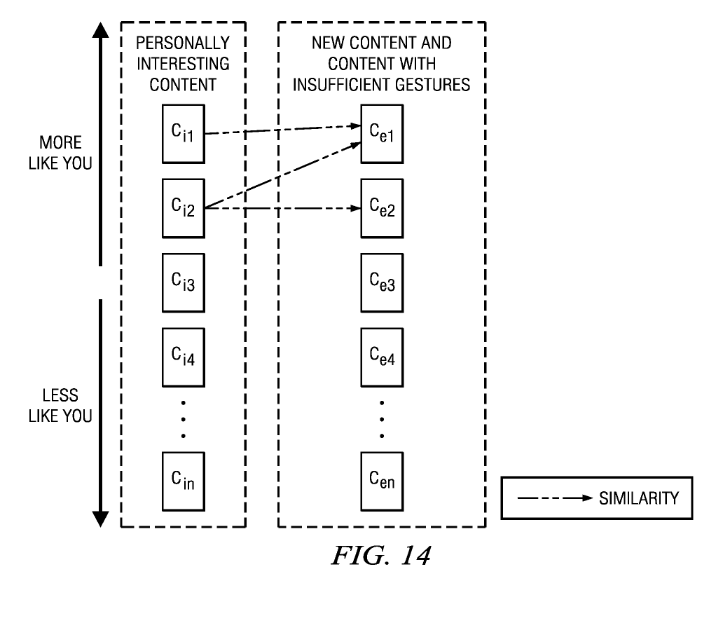

The same technique may be applied to populate the personally interesting content, as illustrated in FIG. 14. To do this, in particular embodiments, whenever new content has been added which lacks sufficient gestures and which matches against a user's personally interesting content, the new content may be inserted into that list. However, the new content is inserted significantly lower in the list than the actual content. This will allow the new content to be available when there is no more closely matching content.

As the number of entertainment choices and delivery methods has grown dramatically, user behaviors and expectations have changed. In the face of overwhelming choice, users now have the challenge of pinpointing content of interest to them and learning how to connect with that content. Through the analysis of socially relevant gestures, it is possible to provide recommendations to users that are both related to the topic at hand and of particular interest to them.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts may operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising:
accessing by a computer system first data describing online activities of a user;
accessing by the computer system second data describing online activities of each of one or more content publishers, each content publisher having published content accessible to the user via a network;
based at least in part on the first data and the second data, determining by the computer system one or more similarities between the user and each of the content publishers;
based at least in part on one or more of the similarities:
selecting by the computer system each of one or more of the content publishers as a key influencer for the user; and
selecting by the computer system particular content published by a particular one of the key influencers for summary and delivery to the user, the particular content selected being more likely to be of interest to the user as a result of one or more of the similarities between the user and the particular one of the key influencers;
generating by the computer system a summary of the particular content; and
automatically delivering by the computer system to the user the particular content and the summary.

2. The method of claim 1, further comprising:
automatically determining by the computer system personal preferences of the user based at least in part on the online activities of the user; and
automatically determining by the computer system personal preferences of each of the content publishers based at least in part on the online activities of the content publisher.

3. The method of claim 2, further comprising:
accessing by the computer system a preference criterion specified by the user; and
determining by the computer system the personal preferences of the user further based on the preference criterion specified by the user.

4. The method of claim 3, further comprising ranking by the computer system the content publishers for the user based on one or more of the similarities between the personal preferences of the user and the personal preferences of each of the content publishers, wherein the relatively more similar between the personal preferences of the user and the personal preferences of the content publisher, the relatively higher the content publisher is ranked.

5. The method of claim 3, wherein, when ranking the content publishers for the user, if the personal preferences of a first content publisher and the personal preferences of a second content publisher are approximately equally similar to the personal preferences of the user and the first content publisher has published more content that are accessible to the user than the second content publisher, then the first content publisher is ranked higher than the second content publisher.

6. The method of claim 1, wherein selecting the particular content published by the key influencers comprises, for each of the key influencers, selecting an instance of the content published by the key influencer that relates to matters with respect to which the user and the key influencer share one or more of the similarities.

7. The method of claim 1, wherein generating a summary of the particular content comprises deduplicating the content.

8. The method of claim 1, wherein the summary is delivered to the user as a Really Simple Syndication (RSS) feed.

9. The method of claim 1, wherein the summary comprises a links that corresponds to one of the particular content.

10. The method of claim 1, further comprising:
receiving feedback with respect to the summary or selected ones of the particular content from the user; and
incorporating the feedback to the first data describing the online activities of the user.

11. The method of claim 10, further comprising, based at least in part on one or more of the similarities and the feedback:
reselecting by the computer system each of one or more of the content publishers as a key influencers for the user;
reselecting by the computer system the particular content published by a particular one of the key influencers;
regenerating by the computer system the summary of the particular content; and
redelivering by the computer system to the user the particular content and the summary.

12. The method of claim 1, further comprising:
generating test content and a test summary for the test content;
delivering to the user the test content and the test summary;
receiving feedback with respect to the test content or the test summary; and
incorporating the feedback to the first data describing the online activities of the user.

13. A system comprising:
a memory comprising instructions executable by a processor; and
a processor coupled to the memory, the processor being operable when executing the instructions to:
access first data describing online activities of a user;
access second data describing online activities of each of one or more content publishers, each content publisher having published content accessible to the user via a network;
based at least in part on the first data and the second data, determine one or more similarities between the user and each of the content publishers;
based at least in part on one or more of the similarities:
select each of one or more of the content publishers as a key influencer for the user; and
select particular content published by a particular one of the key influencers for summary and delivery to the user, the particular content selected being more likely to be of interest to the user as a result of one or more of the similarities between the user and the particular ones of the key influencers;
generate a summary of the particular content; and
automatically deliver to the user the particular content and the summary.

14. The system of claim 13, wherein the processor is further operable when executing the instructions to:
automatically determine personal preferences of the user based at least in part on the online activities of the user; and
automatically determine personal preferences of each of the content publishers based at least in part on the online activities of the content publisher.

15. The system of claim 14, wherein the processor is further operable when executing the instructions to:
access a preference criterion specified by the user; and
determine the personal preferences of the user further based on the preference criterion specified by the user.

16. The system of claim 15, wherein the processor is further operable when executing the instructions to rank the content publishers for the user based on one or more of the similarities between the personal preferences of the user and the personal preferences of each of the content publishers, wherein the relatively more similar between the personal preferences of the user and the personal preferences of the content publisher, the relatively higher the content publisher is ranked.

17. The system of claim 16, wherein, when ranking the content publishers for the user, if the personal preferences of a first content publisher and the personal preferences of a second content publisher are approximately equally similar to the personal preferences of the user and the first content publisher has published more content that are accessible to the user than the second content publisher, then the first content publisher is ranked higher than the second content publisher.

18. The system of claim 13, wherein, to select the particular content published by the key influencers, the processor is operable when executing the instructions to, for each of the key influencers, select an instance of the content published by the key influencer that relates to matters with respect to which the user and the key influencer share one or more of the similarities.

19. The system of claim 13, wherein, to generate a summary of the particular content, the processor is further operable when executing the instructions to deduplicate the content.

20. The system of claim 13, wherein the summary is delivered to the user as a Really Simple Syndication (RSS) feed.

21. The system of claim 13, wherein the summary comprises a link that correspond to one of the particular content.

22. The system of claim 13, wherein the processor is operable when executing the instructions to:
receive feedback with respect to the summary or selected ones of the particular content from the user; and
incorporate the feedback to the first data describing the online activities of the user.

23. The system of claim 22, wherein the processor is operable when executing the instructions, based at least in part on one or more of the similarities and the feedback to:
reselect each of one or more of the content publishers as a key influencer for the user;
reselect the particular content published by a particular one of the key influencers;
regenerate the summary of the particular content; and
redeliver to the user the particular content and the summary.

24. The system of claim 13, the processor is operable when executing the instructions to:
generate test content and a test summary for the test content;
deliver to the user the test content and the test summary;
receive feedback with respect to the test content or the test summary; and
incorporate the feedback to the first data describing the online activities of the user.

25. A computer-readable storage media embodying software operable when executed by a computer system to:
access first data describing online activities of a user;
access second data describing online activities of each of one or more content publishers, each content publisher having published content accessible to the user via a network;
based at least in part on the first data and the second data, determine one or more similarities between the user and each of the content publishers;
based at least in part on one or more of the similarities:
select each of one or more of the content publishers as a key influencer for the user; and
select particular content published by a particular one of the key influencers for summary and delivery to the user, the particular content selected being more likely to be of interest to the user as a result of one or more of the similarities between the user and the particular ones of the key influencers;
generate a summary of the particular content; and
automatically deliver to the user the particular content and the summary.
